(19) United States
(12) Patent Application Publication
(10) Pub. No.: US 2016/0224815 A1
(43) Pub. Date: Aug. 4, 2016

(54) FAST BATCH ENROLL RF6 SENSOR METHOD IN SECURITY PANEL

(71) Applicant: Honeywell International Inc., Morristown, NJ (US)

(72) Inventors: Yekun GAO, Shanghai (CN); Zhonggui LI, Shanghai (CN); Min YE, Shanghai (CN)

(73) Assignee: Honeywell International Inc.

(21) Appl. No.: 14/614,040

(22) Filed: Feb. 4, 2015

(51) Int. Cl. G06K 7/10; G08B 13/24; G06K 7/14; H04N 7/18

(52) U.S. Cl. CPC G06K 7/10722; H04N 7/181; G08B 13/2491; G06K 7/1413; G06K 7/1417

(57) ABSTRACT

An apparatus including a control panel of a security system that protects a secure geographic area, at least one sensor of the security system that detects threats within the secured area, a camera carried by the control panel and a processor coupled to the camera that reads a printed code from the at least one sensor when the at least one sensor is placed in a field of view of the camera, decodes information from the read code and enrolls the at least one sensor with the control panel based upon the decoded information.

### FIELD

This application relates to security systems and more particular to the set-up of such systems.

### BACKGROUND

Systems are known to protect people and assets within secured areas. Such systems are typically based upon the use of one more sensors that detect threats within the secured area.

Threats to people and assets may originate from any of number of different sources. For example, a fire may kill or injure occupants who have become trapped by a fire in a home. Similarly, carbon monoxide from a fire may kill people in their sleep.

Alternatively, an unauthorized intruder, such as a burglar, may present a threat to assets within the area. Intruders have also been known to injure or kill people living within the area.

In the case of intruders, sensors may be placed in different areas based upon the respective uses of those areas. For example, if people are present during some portions of a normal day and not at other times, then sensors may be placed along a periphery of the space to provide protection while the space is occupied while additional sensors may be placed within an interior of the space and used when the space is not occupied.

In most cases, threat detectors are connected to a local control panel. In the event of a threat detected via one of the sensors, the control panel may sound a local audible alarm. The control panel may also send a signal to a central monitoring station.

While security system work well, they are sometimes difficult to set up and use, especially when large numbers of sensors and different levels of security are involved. Accordingly, a need exists for better methods of expediting the setup of such systems.

### BRIEF DESCRIPTION OF THE DRAWINGS

FIG. 1 illustrates a block diagram of a system in accordance herewith;

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

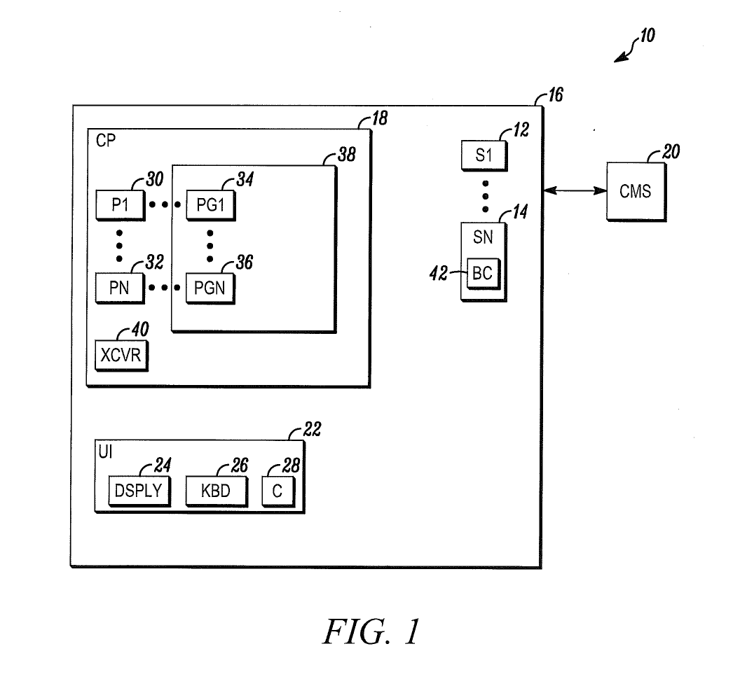

FIG. 1 depicts a security system 10 shown generally in accordance with an illustrated embodiment. Included within the security system may be a number of sensors 12, 14 used for detecting threats within a secured geographic area 16. Threats may originate from any of a number of different sources. For example, an intruder may represent a threat to people and/or assets within a home or business. Similarly, a fire or a gas leak may threaten the safety of those same people and/or assets.

Accordingly, the sensors may be embodied in any of a number of different forms. For example, at least some of the sensors may be limit switches placed on the doors and windows providing entry into and egress from the secured area. Some other of the sensors may be passive infrared (PIR) sensors placed within the secured area in order to detect intruders who have been able to circumvent the sensors along the periphery of the secured area. Still other of the sensors may be smoke and/or fire detectors.

Also included within the secured area is a control panel or controller 18. The control panel may be located within the secured area as shown in FIG. 1 or located remotely.

The control panel may monitor the sensors for activation. Upon activation of one of the sensors, the control panel may compose an alarm message and send it to a central monitoring station 20. The central monitoring station may response by summoning the appropriate help (e.g., police, fire department, etc.).

The security system may be controlled by a human user through use of a user interface 22. Included within the user interface may be a display 24 and a keyboard 26.

Located within the control panel, the user interface and each of the sensors may be one or more processor apparatus (processors) 30, 32, each operating under control of one or more computer programs 34, 36 loaded from a non-transitory computer readable medium (memory) 38. As used herein, reference to a step performed by a computer program is also reference to the processor that executed that step.

The security system may be armed and disarmed through the user interface. In this regard, an authorized user may enter a personal identification number (PIN) and an instruction. The instruction may be an arm instruction, an arm away and/or a disarm command.

A status processor may monitor the user interface for input from the human user. Upon detecting a PIN, the status processor may compare the entered PIN with the PINs of authorized users. If the entered PIN matches the PIN of an authorized user, then the status processor executes the instruction. If not, then the input may be ignored or an error message is generated.

In the armed state, an alarm processor monitors each of the sensors for activation. Upon detecting activation of one of the sensors, the alarm processor composes and sends an alarm message to the central monitoring station. The alarm message may include an identifier of the system (e.g., account number, street address, etc.), an identifier of the sensor and the time of activation.

In general, the sensors of FIG. 1 are wireless devices that each communicate with the control panel on one or more radio frequency channels. Accordingly, a respective radio frequency transceiver 40 located within the control panel and each of the sensors is provided in support of such wireless communication.

For example, the control panel may include one or more communication processors that define a super frame for communication between the control panel and sensors. The super frame, in turn, may be defined by a number of time division multiple access (TDMA) slots that re-occur over a predetermined time period. Some of the slots may be reserved for use by the sensors under a 6LowPan/IPv6/IoT protocol.

The super frame may include a slot reserved for a beacon and slots reserved for the exchange of messages between the sensors and the control panel under an IEEE 802.15.4 and/or 6LowPAN protocol. The beacon may identify a starting point of the super frame and incorporates a number of data fields that each define respective aspects of the superframe

Each sensor of the system of FIG. 1 may have a short address and an IPv6 (6LowPan) address and a MAC identifier (MAC ID). The addressing system facilitates accessing of the sensors by any other IPv6 compatible device as described in various Internet of Things (IoT) publications. This allows the sensors to be arranged by respective processors into star or tree networks.

The status of the control panel (e.g., armed, disarmed, trouble, etc.) may be carried as part of the beacon payload. If necessary, a detailed indicator of panel status may also be carried within respective slots under the 6LowPAN/802.15.4 protocols. The control slots of the beacon may also be used to send request messages from the control panel to end devices (e.g., sensors, etc.) based upon the IEEE802.15.4 addresses of the end devices.

As noted above, any of a number of different types of devices may be incorporated into the system as sensors. The devices may be automatically enrolled into the system via an enrollment processor.

Under one illustrated embodiment, a television camera 28 within the user interface may be used to at least partially automate enrollment of the sensors into the system. The camera may be used to capture an image of a label 42 located on an outside surface of the sensor. The label may be encoded using an appropriate visual coding format (e.g., bar code, QR code, etc.). The label provides detailed information about the sensor (e.g., an identifier of the manufacturer, a model number, MAC ID, serial number, revision number, etc.).

In this regard, a decoding processor within the television camera or control panel decodes an image of the sensor label from the camera in order to recover registration information from the sensor. The recovered information may be saved as a white list pending registration of the sensor.

Once activated, the sensor begins by scanning an appropriate radio frequency spectrum for a beacon from the control panel. A registration processor within the sensor recovers a system identifier from the beacon as well as registration information (e.g., a format under which the sensor may register, a channel on which to send registration requests, etc.).

The registration processor may then send a registration request to the control panel. The registration request may include operational information (i.e., a profile) about the sensor (e.g., an identifier of the manufacturer, a model number, MAC ID, serial number, revision number, etc.).

Within the control panel, a corresponding registration processor receives the registration request and attempts to match the content of the registration request with an entry within the white list. Upon finding a match, the registration processor registers the sensor into the system and assigns the sensor to a particular zone of the secured area. To complete registration, the registration processor may assign the sensor to a particular slot of the superframe.

In general, the system of FIG. 1 offers a number of advantages over conventional systems. For example, currently available systems enroll RF6 sensors into a corresponding control panel under a manual learning mode using a number of predefined steps. First, a user (working through a control panel of a security system) enters into a zone programming screen and sends an enrollment mode command to an RF6 application (RF6AP) within the control panel. The user then removes and re-inserts the battery into the RF 6 sensor, thereby causing the sensor to transmit a profile to the panel over a selected radio frequency channel. The profile is, in turn, displayed on the user interface. The user then compares the MAC address in the profile to the information printed on the outside of the sensor. If the information matches, the user saves the information into a file of a particular zone. The user may then step into the next zone and enroll the next sensor.

There are several problems with this process. For example, a user needs to wait several second (often more than 10 seconds) for the RF6 sensor and RF6AP of the network to pair (e.g., to recognize one another, to establish a communication connection, to exchange registration information, etc.). The user may then need to compare the MAC address in the profile received over the radio frequency channel with the printed information on the sensor in order to decide whether to accept the device, or not. This wastes a considerable amount of time.

In addition, the user may mistakenly accept a sensor belonging to another nearby system. When this happens, the user must delete that sensor and start over. Often removal of the wrong sensor requires special software tools. This adds to the installation costs.

The system of FIG. 6 solves these problems in a number of ways. First, the camera built into the user interface acts as a bar code scanner that scans each sensor's barcode to automatically form the sensors' MAC white list within the control panel, to provide that information to a registration processor and to display the white list on the user interface. The user may then remove and re-install the sensor's battery to pair the RF6 sensor with the security system network. The corresponding processor accepts the RF6 sensor as a corresponding zone type based on the sensor information in the scanned profile. This strategy based upon the MAC white list and upon camera scanning avoids mistakes caused by the presence of other nearby sensors. In effect, the scanning of profile information provides an automated pipeline enrollment operation that saves a considerable amount of installation time. The RF6 profile recovered from the camera image provides sufficient information to allow a registration processor to match and automatically enroll the sensor based upon zone type.

As a more specific example, the user of the user interface of FIG. 1 enters into a RF6 sensor batch learning mode by activating a corresponding icon on the user interface. The user may select a zone or zone type (or the system may do this automatically based upon a predefined list of zones). The user scans the barcode on the RF6 sensor using the camera and waits for the MAC address and associated information to appear in the white list. The user resets the sensor (e.g., by removing and re-installing the battery). When the profile arrives over the RF interface, the registration processor automatically enrolls the sensor into the corresponding zone. The process may then be repeated.

In general, the system includes a control panel of a security system that protects a secure geographic area, at least one sensor of the security system that detects threats within the secured area, a camera carried by the control panel, and a processor coupled to the camera that reads a printed code from the at least one sensor when the at least one sensor is placed in a field of view of the camera, decodes information from the read code and enrolls the at least one sensor with the control panel based upon the decoded information.

Alternatively, the system includes a security system that protects a secure geographic area, at least one sensor of the security system that detects threats within the secured area, a control panel of the security system that monitors the at least one sensor, a camera carried by the control panel and a processor coupled to the camera that reads a code from the at least one sensor when the at least one sensor is placed in a field of view of the camera, decodes information from the read code and enrolls the at least one sensor with the control panel based upon the decoded information.

Alternatively, the system includes a security system that protects a secure geographic area, at least one sensor of the security system that detects threats within the secured area, a controller of the security system that monitors the at least one sensor, a camera electrically coupled to the controller and a processor of the controller coupled to the camera that optically reads a code from the at least one sensor, decodes information from the read code and enrolls the at least one sensor with the control panel based upon the decoded information.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a control panel of a security system that protects a secure geographic area;
at least one wireless sensor of the security system that detects threats within the secured area;
a camera carried by the control panel; and
a processor coupled to the camera that reads a printed code from the at least one sensor when the at least one sensor is placed in a field of view of the camera, decodes information from the read code and enrolls the at least one sensor with the control panel based upon the decoded information.

2. The apparatus as in claim 1 wherein the read code further comprises one of a bar code and QR code.

3. The apparatus as in claim 1 wherein the decoded information comprises one or more of a MAC address, a manufacturer, a model number and a revision code.

4. The apparatus as in claim 1 wherein a processor of the at least one sensor transmits a registration request to the control panel.

5. The apparatus as in claim 4 further comprising a processor that matches the transmitted information of the registration request with the information read by the camera.

6. The apparatus as in claim 1 further comprising a processor that enrolls the at least one sensor within a zone of the secured area.

7. The apparatus as in claim 1 further comprising a display of the security system that displays the secured information.

8. An apparatus comprising:
a security system that protects a secure geographic area;
at least one wireless sensor of the security system that detects threats within the secured area;
a control panel of the security system that monitors the at least one sensor;
a camera carried by the control panel; and
a processor coupled to the camera that reads a code from the at least one sensor through an image from the camera when the at least one sensor is placed in a field of view of the camera, decodes information from the read code and enrolls the at least one sensor with the control panel based upon the decoded information.

9. The apparatus as in claim 8 wherein the read code further comprises a bar code or QR code.

10. The apparatus as in claim 8 wherein the decoded information comprises one or more of a MAC address, a manufacturer, a model number and a revision code.

11. The apparatus as in claim 8 wherein a processor of the at least one sensor wirelessly transmits a registration request to the control panel.

12. The apparatus as in claim 11 further comprising a processor that matches the information of the registration request with the information read by the camera.

13. The apparatus as in claim 8 further comprising a processor that enrolls the at least one sensor within a zone of the secured area.

14. The apparatus as in claim 8 further comprising a display of the security system that displays the secured information.

15. An apparatus comprising:
a security system that protects a secure geographic area;
at least one wireless sensor of the security system that detects threats within the secured area;
a controller of the security system that monitors the at least one sensor;
a camera electrically coupled to the controller that collects an image of the at least one sensor; and
a processor of the controller coupled to the camera that optically reads a code from the collected image, decodes information from the read code and enrolls the at least one sensor with the control panel based upon the decoded information.

16. The apparatus as in claim 15 wherein the read code further comprises a bar code.

17. The apparatus as in claim 15 wherein the decoded information comprises a MAC address.

18. The apparatus as in claim 15 wherein a processor of the at least one sensor transmits a registration request to the control panel.

19. The apparatus as in claim 15 further comprising a processor that matches the information of the registration request with the information read by the camera.

20. The apparatus as in claim 15 further comprising a display of the security system that displays the secured information.
